(19) United States
(12) Patent Application Publication
(10) Pub. No.: US 2011/0149473 A1
(43) Pub. Date: Jun. 23, 2011

(54) ENERGY STORAGE IN EDLCS BY UTILIZING A DIELECTRIC LAYER

(76) Inventors: Thor E. Eilertsen, Oneonta, NY (US); Daniel A. Patsos, Otego, NY (US)

(21) Appl. No.: 12/974,647

(22) Filed: Dec. 21, 2010

Related U.S. Application Data
(60) Provisional application No. 61/288,560, filed on Dec. 21, 2009.

(51) Int. Cl. H01G 9/07; H01G 9/155; B82Y 30/00

(52) U.S. Cl. 361/502; 29/25.03; 977/750; 977/734; 977/752; 977/948

(57) ABSTRACT

A composition comprising an electrode or an electrical double-layer capacitor with dielectric material is disclosed, along with methods of making the composition. The present invention improves upon state-of-the-art electrodes and capacitors by coating a material of high dielectric constant onto the surface of the electrode to produce improved electrical properties. The composition is particularly useful for design of novel electrical double-layer capacitors.

### CROSS REFERENCE TO RELATED APPLICATIONS

The present application claims priority to U.S. Provisional Application No. 61/288,560, filed Dec. 21, 2009, the disclosure of which is herein incorporated by reference in its entirety for all purposes.

### BACKGROUND

In a conventional capacitor, energy is stored by the removal of charge carriers, typically electrons, from one metal plate and depositing them on another. This charge separation creates a potential between the two plates, which can be harnessed in an external circuit. The total energy stored in this fashion is proportional to both the number of charges stored and the potential between the plates. The number of charges stored is essentially a function of size and the material properties of the plates, while the potential between the plates is limited by the dielectric breakdown. Different materials sandwiched between the plates to separate them result in different voltages to be stored. Optimizing the material leads to higher energy densities for any given size of capacitor.

In contrast with traditional capacitors, electric double-layer capacitors (“EDLC”) do not have a conventional dielectric. Rather than two separate plates separated by an intervening substance, these capacitors use “plates” that are in fact two layers of the same substrate, the so-called “electrical double layer”, and their electrical properties result in the effective separation of charge despite the vanishingly thin (on the order of nanometers) physical separation of the layers. The lack of need for a bulky layer of dielectric permits the packing of “plates” with much larger surface area into a given size, resulting in their extraordinarily high capacitances in practical sized packages.

### SUMMARY

In a capacitor, energy density is a function of voltage stability as well as capacitance, as reflected by the equation: E=½CV². In an EDLC, each layer by itself is quite conductive, but the physics at the interface where the layers are effectively in contact means that no significant current can flow between the layers. However, the double layer can withstand only a low voltage due to dielectric breakdown of the separator material. The limiting factor in current EDLCs with respect to voltage breakdown is the intrinsic breakdown characteristics of the electrolyte. Therefore, improving the ability of the system to withstand a higher voltage would allow more energy to be stored. There are a limited number of options currently available, and most EDLC manufacturers use either acetonitrile (ACN) or propylene carbonate (PC) as the electrolyte. Minimizing impurities and water content in the system is also directly related to voltage breakdown in EDLCs. Ultimately, these limitations mean that current electric double-layer capacitors rated for higher voltages must be made of matched series-connected individual electric double-layer capacitors, much like series-connected cells in higher-voltage batteries.

In general, electric double-layer capacitors improve storage density through the use of a nanoporous material, typically activated carbon, in place of the conventional insulating barrier. An activated carbon/conductive carbon mixture is currently the most cost effective approach to high surface area EDLC electrodes. Activated carbon is a powder made up of micro- and/or nanoscale particles, which in bulk form a low-density volume of particles with holes between them that resembles a sponge. Materials synthesis and activation process parameters including optimized particle morphology and pore structure have a large effect on surface area, and more importantly, effective surface area when in contact with a particular electrolyte. (see e.g., Mastragostino et al., Chapter 16, Advances in Lithium Ion Batteries, Kluwer Academic (2002), hereby incorporated by reference). The overall surface area of even a thin layer of such a material is many times greater than a traditional material like aluminum, allowing many more charge carriers (ions or radicals from the electrolyte) to be stored in any given volume. This high surface area must be maintained as much as possible during the production techniques required to form the completed EDLC electrode system.

Improving energy density of electrochemical double layer capacitors has been a priority for EDLC manufacturers. One solution used for increasing charge storage is to make a pseudo capacitor which is one half metal oxide battery electrode and one half carbon electrode. Pseudo electrochemical double layer capacitors can have effectively double the capacitance for the same volume of an EDLC. These devices have much lower maximum discharge rates and higher internal resistance than EDLCs since they are half battery. The pseudo EDLC solution is limited in application because of these limitations. Other solutions for improving energy storage focus on refinements in the carbon structures used, such as use of carbon nanotubes, which can be very expensive to manufacture.

Much of the current research focus for improving and optimizing EDLCs is directed at increasing the usable surface area of the electrodes and improving the voltage breakdown of the electrolyte. The present invention substantially improves upon the current state of the art by combining double layer capacitor technology with ferroelectric capacitance. Ferroelectric capacitance is the generation of charge separation by the physical movement of positively and negatively charged atoms with respect to one another in the material's crystal structure. The energy for this physical rearrangement is provided by the applied electric field. At the external surface of the ferroelectric particle, the crystal structure is incomplete, with unbonded elements interacting in unpredictable ways with the surrounding material, in this case the electrolyte. This creates a much higher energy state at the surface of particles compared with the energy state in the bulk of the particle. Rearrangement of these surface atoms requires much greater amounts of energy, and, as such, they become effectively constrained from polarizing and cannot contribute to energy storage in a predictable way.

As the particle size of the ferroelectric decreases, an increasingly higher percentage of the crystal structure in the particle are affected by this higher energy state and constraining force at the surface. At some minimum particle size, the random interactions and constraining force at the surface of the particles outweighs the generation of directional polarization within the particle and measurable, usable ferroelectricity ceases to exist. The commonly stated minimum particle size in commercially available materials is 50 nm. This is much greater than the features in the activated carbon in the EDLC electrodes, and as such, a coating this thick would likely detract from the effective surface area and limit the overall capacitance enhancement of the system to approximately double that of current electrodes.

In one embodiment, the present invention provides synthesis techniques for the preparation of dielectric materials which retain their ferroelectric properties at much smaller particle sizes, improving the synergy with structural electrode dimensions commonly present in EDLC systems and enabling a much greater energy density enhancement. As used herein, “dielectric material” (also referred to herein as “ferroelectric materials”) can be any material having a spontaneous electric polarization that can be reversed by the application of an external field, including, for example, ferroelectric, piezoelectric, or pyroelectric materials. For example, the improvements can be accomplished by adding a very thin coating, approaching a monolayer, of a material of high dielectric constant onto the surface of the carbon electrode. The effective surface area will be made active in two simultaneous processes, i.e. charging of the double layer creating double layer capacitance, and polarizing the ceramic particles, creating ferroelectric capacitance (for details of ferroelectric capacitance, see Hong, Nanoscale Phenomena in Ferroelectric Thin Films, Springer (2004), hereby incorporated by reference). This process can be used to develop a nanoscale micro-structured electrode that can be incorporated in manufacturing processes to achieve specific capacitances of about 20 F/g or greater.

### FIGURES

FIG. 1 shows a schematic of a device comprising positive and negative current collectors, porous electrodes coated with a material to enhance capacitance of the device, a separator film, and an electrolyte in the space surrounding the coated electrode material.

FIG. 2 compares dielectric constant (Δ) and 2θ ( ) as a function of x in BaₓSr₁₋ₓTiO₃. As can be seen in the figure, when x=0.70, (Ba_{0.7}Sr_{0.3}TiO₃), the dielectric constant spikes to ˜140,000. The X-ray diffraction data shows particles size for BaTiO₃, SrTiO₃, and Ba_{0.7}Sr_{0.3}TiO₃.

FIG. 3 shows potential building blocks for use in the design of polymer electrolytes with properties potentially conducive to high ionic conductivity useful for the present invention.

FIG. 4 shows the discharge curves of doped vs. undoped electrodes. The area under the curve corresponds to the energy stored, and is seen to increase by ˜50% in barium strontium titanate (“BSTO”)-coated electrodes. The increase in capacitance in initial trials was ˜50%.

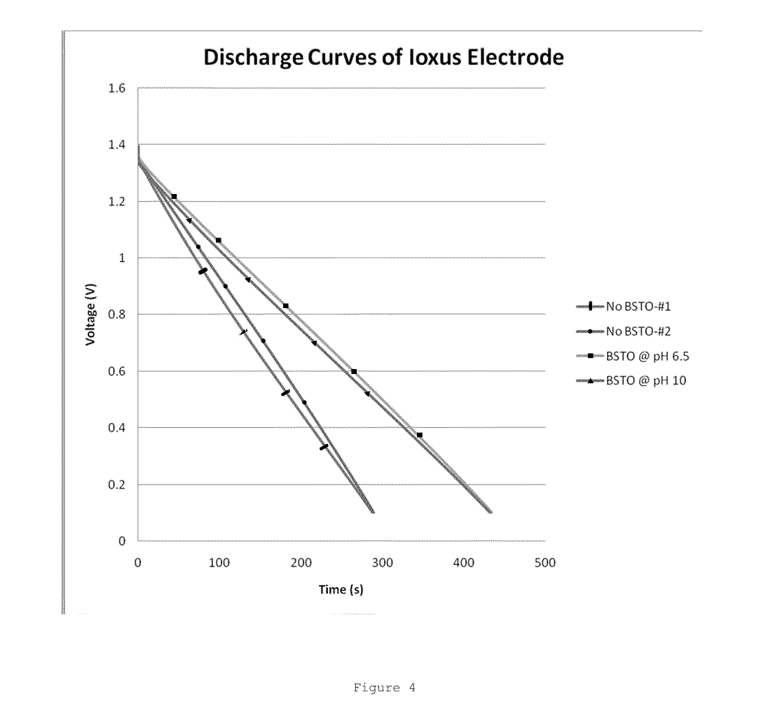

### DETAILED DESCRIPTION

The present invention is directed to novel electrical double-layer capacitor devices, and methods and processes related to making said devices. One embodiment provides a combination of an EDLC electrode material with a dielectric material. One embodiment provides a high-energy density device comprising an EDLC and a dielectric material. In one embodiment, the device comprises an EDLC and a dielectric material wherein the dielectric material interacts with the EDLC's electrode material. In some embodiments, the device will have an energy density on the order of 15-50 Wh/kg. In some embodiments, the device will have an energy density greater than 20 Wh/kg, greater than 30 Wh/kg, greater than 40 Wh/kg, or greater than 50 Wh/kg.

Another embodiment provides a device comprising an electric double-layer capacitor (“EDLC”) comprising a positively charged current collector; a negatively charged current collector; a positive electrode in contact with the positively charged current collector; a negative electrode in contact with the negatively charged current collector; an electrolyte; and a separator; and a dielectric material in physical contact with at least one of the electrodes.

Another embodiment provides a device comprising an EDLC and a dielectric material in physical contact with at least one of the EDLC electrodes, wherein at least one of the EDLC electrodes comprises carbon. In some embodiments, the carbon electrode has a porous structure. In some embodiments, the porous structure comprises a pore size distribution, as determined from a nitrogen adsorption isotherm, in which pores with a radius of up to 100 Å account for at most 50% of the total pore volume. In some embodiments, the carbon structure has a density of about 1.8-2.3 g/cm³. In some embodiments, the carbon comprises single-walled carbon nanotubes, fullerenes, multi-walled carbon nanotubes, diamond-like carbon, diamond, nanocrystalline diamond, diamondoids, amorphous carbon, carbon particles, carbon powder, microspheres, graphite, graphene, carbon fiber, carbon felt, graphitic polyhedral crystals, highly ordered pyrolytic graphite, activated carbon, xerogels, aerogels, nanostructured carbon, or hydrogenated amorphous carbon. In some embodiments, the carbon comprises activated carbon with an average particle size less than 20 □m. In some embodiments, the carbon has a specific surface area greater than 2350 m²/g as measured by the nitrogen adsorption BET method.

Another embodiment provides a device comprising an EDLC and a dielectric material in physical contact with at least one of the EDLC electrodes, wherein the electrolyte in the EDLC comprises an aqueous, non-aqueous, or polymeric material. In some embodiments, the electrolyte is a polymer. In some embodiments, the polymer comprises a PEO-based copolymer.

Another embodiment provides a device comprising an EDLC and a dielectric material in physical contact with at least one of the EDLC electrodes, wherein the dielectric material comprises a ferroelectric, piezoelectric, or pyroelectric material. In some embodiments, the dielectric material comprises an inorganic compound or polymer. In some embodiments, the dielectric material comprises an inorganic compound. In some embodiments, the inorganic material is a ceramic. In some embodiments, the dielectric material comprises a colloid, a mixture, a film, adhered particles, or deposited particles. In some embodiments, the dielectric material comprises nanoparticles, microparticles, or a film. In some embodiments, the dielectric material has an average particle size from about 1 nm to about 500 nm. In some embodiments, the film has a thickness from about a monolayer to about 1000 nm. In some embodiments, the nano- or microparticles form a film. In some embodiments, the dielectric material comprises a film. In some embodiments, the dielectric material comprises nanoparticles. In some embodiments, the dielectric material comprises an inorganic compound or polymer, wherein the inorganic compound or polymer comprises barium titanate, strontium titanate, barium strontium titanate, bismuth ferrite, colemanite, germanium telluride, lead scandium tantalate, lead zirconium titanate, lithium niobium oxide, potassium sodium tartrate, or potassium titanium phosphate and the polymer comprises polyvinylidene fluoride. In some embodiments, the dielectric material comprises an inorganic compound, wherein the inorganic compound comprises Ba₁₋ₓSrₓTiO₃, PbZr₁₋ₓTiₓO₃ or Pb_{y}La_{z}(Zr₁₋ₓTiₓ)O₃ wherein x is between from about 0.0 to about 1.0, y is from about 0.95 to about 1.25 and z is between from about 0 to about 0.15, Bi₃ₓZn₂₍₁₋ₓ₎Nb₂₋ₓO₇ wherein x is between from about 0.40 to about 0.75, or SrₓBi_{y}Ta₂O_{5+x+3y/2} wherein x is between from about 0.50 to about 1.0 and y is between from about 1.9 to about 2.5. In some embodiments, the inorganic compound comprises Ba₁₋ₓSrₓTiO₃ wherein x is between from about 0.0 to about 1.0.

Another embodiment provides a device comprising an EDLC and a dielectric material in physical contact with at least one of the EDLC electrodes, wherein the dielectric material comprises nanoparticles, microparticles, or a film wherein the particles or film are chemically bound, adhered to, adsorbed to, precipitated on, or deposited on at least one electrode.

Another embodiment provides a device comprising an EDLC comprising a porous electrode and a dielectric material, wherein the dielectric material is a coating on the porous electrode.

Another embodiment provides a device comprising an EDLC comprising a porous electrode with nano-scale pores and a dielectric material, wherein the dielectric material comprises a coating on the porous electrode.

Another embodiment provides a device comprising an EDLC comprising a carbon electrode and a dielectric material, wherein the dielectric material comprises a coating on the carbon electrode.

Another embodiment provides a device comprising an EDLC comprising a carbon electrode, a dielectric material, wherein the dielectric material comprises a coating on the carbon electrode, and a aqueous electrolyte.

Another embodiment provides a device comprising an EDLC comprising a carbon electrode, a dielectric material, wherein the dielectric material comprises a coating on the carbon electrode, and a non-aqueous electrolyte.

Another embodiment provides a device comprising an EDLC comprising a carbon electrode, a dielectric material, wherein the dielectric material comprises a coating on the carbon electrode, and a polymer electrolyte.

Another embodiment provides a device comprising an EDLC comprising a carbon electrode, a dielectric material, wherein the dielectric material comprises a coating of nanoparticles on the carbon electrode.

Another embodiment provides a device comprising an EDLC comprising a carbon electrode, a dielectric material, wherein the dielectric material comprises a coating with a nanometer-scale thickness on the carbon electrode.

Another embodiment provides a device comprising an EDLC comprising a carbon electrode, a dielectric material, wherein the dielectric material comprises a monolayer coating on the carbon electrode.

Another embodiment provides a device comprising an EDLC comprising a carbon electrode, a dielectric material, wherein the dielectric material fully coats the carbon electrical double layer.

Another embodiment provides a device comprising an EDLC comprising a carbon electrode, a dielectric material, wherein the dielectric material partially coats the carbon electrical double layer.

Another embodiment provides a device comprising an EDLC comprising a carbon electrode, and a ferroelectric material in physical contact with at least one of the EDLC electrodes, wherein the dielectric material is Ba₁₋ₓSrₓTiO₃, PbZr₁₋ₓTiₓO₃ or Pb_{y}La_{z}(Zr₁₋ₓTiₓ)O₃ wherein x is between from about 0.0 to about 1.0, y is from about 0.95 to about 1.25 and z is between about 0 to about 0.15, Bi₃ₓZn₂₍₁₋ₓ₎Nb₂₋ₓO₇ wherein x is between from about 0.40 to about 0.75, or SrₓBi_{y}Ta₂O_{5+x+3y/2} wherein x is between from about 0.50 to about 1.0 and y is between from about 1.9 to about 2.5. In some embodiments, x, y, and z are optimized to maximize the dielectric constant of the ferroelectric material.

Another embodiment provides a device comprising an EDLC and a dielectric material in physical contact with at least one of the EDLC electrodes, wherein the dielectric material is a ceramic. The ceramic can include, but is not limited to Ba₁₋ₓSrₓTiO₃, PbZr₁₋ₓTiₓO₃ or Pb_{y}La_{z}(Zr₁₋ₓTiₓ)O₃ wherein x is between from about 0.0 to about 1.0, y is from about 0.95 to about 1.25 and z is between from about 0 to about 0.15, Bi₃ₓZn₂₍₁₋ₓ₎Nb₂₋ₓO₇ wherein x is between from about 0.40 to about 0.75, or SrₓBi_{y}Ta₂O_{5+x+3y/2} wherein x is between from about 0.50 to about 1.0 and y is between from about 1.9 to about 2.5. In some embodiments, x, y, and z are optimized to maximize the dielectric constant of the dielectric material.

Another embodiment provides a device comprising an EDLC and a dielectric material in physical contact with at least one of the EDLC electrodes, wherein the dielectric material is Ba₁₋ₓSrₓTiO₃ wherein x is between from about 0.0 to about 1.0. In some embodiments, x is optimized to maximize the dielectric constant of the dielectric material.

Another embodiment provides a device comprising an EDLC and a dielectric material in physical contact with at least one of the EDLC electrodes, wherein the dielectric material is Ba₁₋ₓSrₓTiO₃, wherein the Ba₁₋ₓSrₓTiO₃ is a ceramic, wherein x is between from about 0.0 to about 1.0. In some embodiments, x is from about 0.2 to about 0.4. In some embodiments, x is about 0.3. In some embodiments, x is optimized to maximize the dielectric constant of the dielectric material.

Another embodiment provides a device comprising an EDLC comprising a carbon electrode and a dielectric material in physical contact the carbon electrode, wherein the carbon electrode comprises a carbon allotrope. A carbon allotrope can include, but is not limited to, single-walled carbon nanotubes, fullerenes, multi-walled carbon nanotubes, diamond-like carbon, diamond, nanocrystalline diamond, diamondoids, amorphous carbon, carbon particles, carbon powder, microspheres, graphite, graphene, carbon fiber, carbon felt, graphitic polyhedral crystals, highly ordered pyrolytic graphite, activated carbon, xerogels, aerogels, nanostructured carbon, or hydrogenated amorphous carbon. The carbon nanotubes may be present in different morphologies such as ropes, bundles, single filaments, tangled webs, etc.

Another embodiment provides a device comprising an EDLC comprising a carbon electrode and a dielectric material in physical contact the carbon electrode, wherein the carbon electrode comprises a carbon allotrope and wherein the dielectric material is a ceramic. The ceramics can include, but are not limited to Ba₁₋ₓSrₓTiO₃, PbZr₁₋ₓTiₓO₃ or Pb_{y}La_{z}(Zr₁₋ₓTiₓ)O₃ wherein x is between from about 0.0 to about 1.0, y is from about 0.95 to about 1.25 and z is between from about 0 to about 0.15, Bi₃ₓZn₂₍₁₋ₓ₎Nb₂₋ₓO₇ wherein x is between from about 0.40 to about 0.75, or SrₓBi_{y}Ta₂O_{5+x+3y/2} wherein x is between from about 0.50 to about 1.0 and y is between from about 1.9 to about 2.5. In some embodiments, x, y, and z are optimized to maximize the dielectric constant of the dielectric material.

In another embodiment, the device may further comprise an insulator or separator between the electrodes. Insulators include, but are not limited to, organic, organometallic and inorganic insulators. Examples of insulators include metal oxides, non-metal oxides, metal hydroxides, non-metal hydroxides, metal halides, non-metal halides, metal hydrides, non-metal hydrides, self-assembled monolayers, plastics and polymers such as poly(ethylene oxide), poly(propylene oxide) and poly(vinylidene fluoride).

Methods of preparing the devices of the present invention are described as well. In one embodiment, the method comprises forming a dielectric material and placing said dielectric material in physical contact with at least one electrode of an EDLC. In some embodiments, said physical contact comprises chemically binding, adhering, adsorbing, precipitating, or depositing said dielectric material. In some embodiments, said forming a dielectric material comprises coprecipitation, hydrothermal methods, solvothermal methods, sol-gel processes, processes mediated by molten composite hydroxide, room-temperature synthesis, biological synthesis, low-temperature synthesis, or synthesis using reverse micelles. In some embodiments, said forming a dielectric material comprises a low-temperature synthesis. In some embodiments, wherein said low-temperature synthesis occurs at temperatures less than 100° C. at standard pressure. In some embodiments, placing said dielectric material comprises electrophoretic deposition, sol-gel synthesis, atomic layer deposition, physical vapor deposition, chemical vapor deposition, vacuum deposition, or chemical solution deposition. In some embodiments, placing said dielectric material comprises electrophoretic deposition or chemical solution deposition.

In another embodiment, the method comprises forming a dielectric material and placing said dielectric material in physical contact with at least one electrode of an EDLC, then simultaneously charging the electrode and polarizing said dielectric material.

Another embodiment provides a hybrid device comprising any of the devices as described in the present application; and a battery. In some embodiments, the device and battery are in chemical or electrical contact.

When used in the present application:

The terms “electrochemical double-layer capacitor” and “EDLC,” include, but are not limited to, a device comprising a positively charged current collector; a negatively charged current collector; a positive electrode in contact with the positively charged current collector; a negative electrode in contact with the negatively charged current collector; an electrolyte; and a separator. The surface area of an electrode within an EDLC, often porous carbon, is on the order of 1,000 m²/g. Most of the surface of the electrode cannot be accessed mechanically, but can be accessed by a liquid or polymer electrolyte. Traditionally, the energy density of an electrochemical capacitor is higher than that of traditional non-electrolytic and electrolytic capacitors, but still lower than that of a battery. Conversely, the power output of an electrochemical capacitor is lower than that of traditional non-electrolytic and electrolytic capacitors, but higher than that of a battery. Moreover, an electrochemical capacitor discharges slower than traditional non-electrolytic and electrolytic capacitors.

The term “carbon” includes all allotropes of carbon including, but not limited to, single-walled carbon nanotubes, fullerenes, multi-walled carbon nanotubes, diamond-like carbon, diamond, nanocrystalline diamond, diamondoids, amorphous carbon, carbon particles, carbon powder, microspheres, graphite, graphene, carbon fiber, carbon felt, graphitic polyhedral crystals, highly ordered pyrolytic graphite, activated carbon, xerogels, aerogels, nanostructured carbon, or hydrogenated amorphous carbon.

The term “ceramic” includes inorganic, non-metallic solids. Ceramic materials of the present invention may have a crystalline or partly crystalline structure, or may be amorphous (e.g., a glass). Ceramics of the present invention should have dielectric properties.

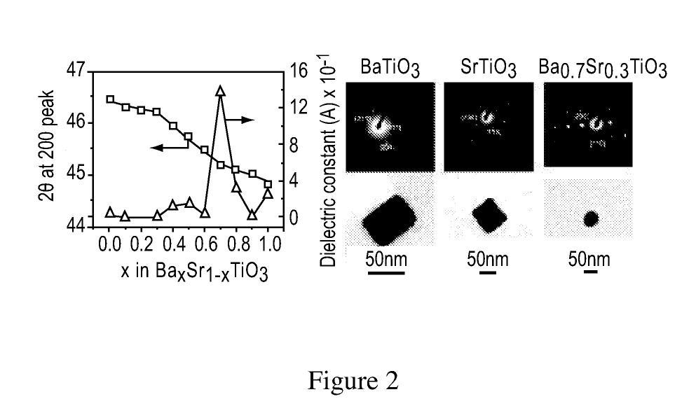

As used herein, “dielectric material” (also referred to herein as “ferroelectric material”) refers to any material having a spontaneous electric polarization that can be reversed by the application of an external field, including, for example, ferroelectric, piezoelectric, or pyroelectric materials. Dielectrics of the present invention should have, but are not limited to materials that have ferroelectric, piezoelectric and/or pyroelectric properties. Dielectrics of the present invention may be ceramics. Examples of dielectric materials include, but are not limited to, materials of the formula Ba₁₋ₓSrₓTiO₃, PbZr₁₋ₓTiₓO₃ or Pb_{y}La_{z}(Zr₁₋ₓTiₓ)O₃ wherein x is between from about 0.0 to about 1.0, y is from about 0.95 to about 1.25 and z is between from about 0 to about 0.15, Bi₃ₓZn₂₍₁₋ₓ₎Nb₂₋ₓO₇ wherein x is between from about 0.40 to about 0.75, or SrₓBi_{y}Ta₂O_{5+x+3y/2} wherein x is between from about 0.50 to about 1.0 and y is between from about 1.9 to about 2.5. In order to maximize the energy storing ability of the device, it is generally desirable to maximize the dielectric coefficient of the dielectric material used. Therefore, the most useful dielectric compounds of the present invention, such as the examples listed above; should have values of x, y, and z that maximize the dielectric coefficient. For example, FIG. 2 shows the dielectric coefficient for a series of BaₓSr₁₋ₓTiO₃ compounds where the dielectric coefficient spikes around x=0.7.

The term “electrode” describes a material that emits or collects electrons or holes or is an electrical conductor used to make contact with a nonmetallic part of a circuit. In some embodiments, as used in the present invention, the term electrode comprises the current collector along with the electrode connected thereto. In some embodiments, the electrode comprises conductive polymers, carbon, nanomaterials, or cellulose. Electrodes of the present invention are preferably carbon. Carbon electrodes of the present invention comprise, but are not limited to single-walled carbon nanotubes, fullerenes, multi-walled carbon nanotubes, diamond-like carbon, diamond, nanocrystalline diamond, diamondoids, amorphous carbon, carbon particles, carbon powder, microspheres, graphite, graphene, carbon fiber, carbon felt, graphitic polyhedral crystals, highly ordered pyrolytic graphite, activated carbon, xerogels, aerogels, nanostructured carbon, or hydrogenated amorphous carbon. Preferably, carbon electrodes comprise activated carbon, graphene, carbon nanotubes, or carbon aerogels. The pore size of the electrode ranges from about 1 nm to about 50 nm. In some embodiments, the pore size ranges from about 1 to 20 nm.

The term “nanoparticle” describes a discrete particle having an average size in at least one dimension less than about 500 nm. In some embodiments the particles have an average size in at least one dimension less than about 100 nm, less than about 50 nm, less than about 25 nm, less than about 10 nm, less than about 5 nm, or less than about 2 nm.

The term “battery” describes one or more electrochemical cells that convert stored chemical energy into electrical energy. In some embodiments, batteries of the present invention include, but are not limited to, Zinc-carbon, zinc-chloride, alkaline (zinc-manganese dioxide), oxy nickel hydroxide, lithium copper oxide, lithium-iron disulfide, lithium-manganese dioxide, mercury oxide, zinc-air, silver-oxide (silver-zinc), NiCd, lead acid, NiMH, NiZn, or lithium ion.

The term “electrolyte” describes any composition that can be used to electrically conduct charge in the ultracapacitor. Electrolytes of the present invention include, but are not limited to, aqueous or non-aqueous solutions containing salts, metals, acids, bases, or solids, such as polymers or beta-alumina solid electrolyte (BASE). In some embodiments, the electrolyte is Tetraethylammonium tetraflouroborate salt with acetonitrile (TEABF₄/ACN) or Tetraethylammonium tetraflouroborate salt with propylene carbonate (TEABF₄/PC).

Properties of dielectric materials—barium titanate (“BTO”) and strontium titanate (“STO”) are among the most studied perovskite ferroelectrics. In the past, most synthesis procedures for the preparation of perovskite crystals included high-temperature (˜1000° C.) sintering followed by annealing. Techniques for forming dielectric materials include, but are not limited to, those focused on establishing moderate reaction conditions, and especially lowering the synthesis temperature for high-quality nanocrystals. (Huang, L. et al., APPL. PHYS. 2006, 100, 034316-10; O'Brien, S. et al., J. AM. CHEM. SOC. 2001, 123, 12085-12086; Urban, J. J. et al., J. AM. CHEM. SOC. 2002, 124, 1186-1187; Niederberger, M. et al., J. AM. CHEM. SOC. 2004, 126, 9120-9126; Niederberger, M. et al., ANGEW. CHEM., Int. Ed. 2004, 43, 2270-2273; Mao, Y. et al., J. AM. CHEM. SOC. 2003, 125, 15718-15719; Nuraje, N. et al., Adv. Mater. 2006, 18, 807-811; Liu, H. et al., NANO LETT. 2006, 6, 1535-1540; Bansal, V. et al., J. AM. CHEM. SOC. 2006, 128, 11958-11963; Brutchey, R. L. and Morse, D. E. ANGEW. CHEM., INT. ED. 2006, 45, 6564-6566, all hereby incorporated by reference).

Additional techniques for forming dielectric materials include, but are not limited to, coprecipitation, (Wada, S. et al., J. CRYST. GROWTH 2001, 229, 433-439; Xu, H. R. and Gao, L. J. AM. CERAM. SOC. 2003, 86, 203-205, both hereby incorporated by reference) sintering of organometallic precursors, (Arya, P. R. et al., J. MATER. CHEM. 2003, 13, 415-423, hereby incorporated by reference.) hydrothermal and solvothermal methods, (Niederberger, M. et al., J. AM. CHEM. SOC. 2004, 126, 9120-9126; Niederberger, M. et al., ANGEW. CHEM., INT. ED. 2004, 43, 2270-2273; Dutta, P. K. and Gregg, J. R. CHEM. MATER. 1992, 4, 843-846; Dutta, P. K. et al., CHEM. MATER. 1994, 6, 1542-1548; Urn, M. H. and Kumazawa, H. J. MATER. SCI. 2000, 35, 1295-1300; Mao, Y. et al., CHEM. COMMUN. 2003, 3, 408-409, all hereby incorporated by reference) sol-gel processes, (O'Brien, S. et al., J. AM. CHEM. SOC. 2001, 123, 12085-12086; Frey, M. H. and Payne, D. A. CHEM. MATER. 1995, 7, 123-129, both hereby incorporated by reference) and procedures mediated by molten composite hydroxide. (Liu, H. et al., NANO LETT. 2006, 6, 1535-1540, hereby incorporated by reference).

In addition to the above-listed methods, other low-temperature methods may be used which allow for the formation of ferroelectric nanocrystals, such as the room-temperature synthesis of ferroelectric nanocrystals with diameters from 6 to 12 nm using a bolaamphiphilic peptide ring as the template (Nuraje, N. et al., ADV. MATER. 2006, 18, 807-811, hereby incorporated by reference), fungus-mediated biological synthesis of tetragonal barium titanate nanoparticles at dimensions smaller than 10 nm under ambient conditions (Bansal, V. et al., J. AM. CHEM. SOC. 2006 128, 11958-11963, hereby incorporated by reference), and the room-temperature synthesis of BTO from a bimetallic alkoxide precursor in a bioinspired process (Brutchey, R. L. and Morse, D. E. ANGEW. CHEM., INT. ED. 2006, 45, 6564-6566, hereby incorporated by reference) Further, nonaqueous approaches may be used to synthesize nanocrystalline BTO, STO, and BaₓSr₁₋ₓTiO₃ mixed-metal oxides using elemental alkaline earth metals as starting materials (Niederberger, M. et al., J. AM. CHEM. SOC. 2004, 126, 9120-9126; Petkov, V. et al., CHEM. MATER. 2006, 18, 814-821, both hereby incorporated by reference). For example, the reaction between a metallic salt and a metallic oxide in a solution of a composite hydroxide eutectic at ˜200° C. has produced, nanometer-sized BTO and BaₓSr₁₋ₓTiO₃ (Liu, H. et al., NANO LETT. 2006, 6, 1535-1540, hereby incorporated by reference).

Techniques for synthesizing dielectric compounds also include bench top synthetic methods. These methods include, but are not limited to, reverse micelles. For example, titanium tetrachloride, strontium chloride, and barium chloride, aqueous solutions were used as starting materials without organic components to obtain high-quality, homogeneous barium strontium titanate nanocrystals. Representative experimental procedures for the synthesis of BaₓSr₁₋ₓTiO₃ nanocrystals are described in detail in K. Su et al., LANGMUIR 2007, 23, 11369-11372, hereby incorporated by reference, and International Appl. No. PCT/US2007/080209 (published as WO 2008/153585, hereby incorporated by reference).

The relative amounts of the atomic and/or molecular components of the dielectric material and the dielectric's purity have an effect on the properties of the ultracapacitor. For example, control of the Ba²⁺/Sr²⁺ molar ratio in the barium strontium titanate nanocrystals plays an important role in the crystal structure of the dielectric, as well as the dielectric constant (see FIG. 2) (Su, K. et al., LANGMUIR 2007, 23, 11369-11372, hereby incorporated by reference).

Techniques for depositing the coating on the electrode include, but are not limited to, the following:

Electrophoretic Deposition—electrophoretic deposition, as used herein, is directed at processes that use colloidal particles suspended in a liquid medium, which are deposited on an electrode through electrophoresis. Liquids used in electrophoretic deposition can be aqueous or non-aqueous. Electrophoretic deposition includes, but is not limited to, electrocoating, e-coating, cathodic electrodeposition, and electrophoretic coating, or electrophoretic painting.

Sol-gel synthesis—sol-gel synthesis, as used herein, is a wet-chemical technique for the fabrication of materials starting from a chemical solution that reacts to produce nanosized colloidal particles (or sol). Typical precursors are metal alkoxides and metal chlorides, which undergo hydrolysis and polycondensation reactions to form a colloid. The result is a system composed of solid particles (size ranging from 1 nm to 1 micron) dispersed in a solvent. The ceramic particles precipitate out through condensation reactions as the temperature is increased and the solvent evaporates. The surface of the carbon electrode acts as a seed and can cause precipitation to occur directly on its surface.

Atomic Layer Deposition—ALD, as used herein, describes any thin film deposition technique that is based on the sequential use of a gas phase chemical process. Generally, the majority of ALD reactions use two chemicals, typically called precursors. These precursors react with a surface one-at-a-time in a sequential manner. By exposing the precursors to the growth surface repeatedly, a thin film is deposited.

Physical vapor deposition (PVD)—PVD includes, but is not limited to evaporative deposition, electron beam PVD, sputter deposition, cathodic arc deposition, and pulsed laser deposition. PVD, as used herein, describes any of a variety of methods to deposit thin films by the condensation of a vaporized form of the material onto various surfaces. The coating method involves purely physical processes, such as high temperature vacuum evaporation or plasma sputter bombardment, rather than involving a chemical reaction at the surface to be coated as in chemical vapor deposition.

Chemical vapor deposition (CVD)—CVD, as used herein, describes chemical processes for producing thin films on a substrate, wherein the substrate is exposed to one or more volatile precursors that react and/or decompose on the substrate surface to produce the desired film material. For example, CVD may include atmospheric pressure CVD, low-pressure CVD, ultrahigh vacuum CVD, aerosol assisted CVD, direct liquid injection CVD, plasma-based CVD such as microwave CVD, plasma-enhanced CVD, remote plasma-enhanced CVD, atomic layer CVD, combustion CVD, hot wire CVD, metalorganic CVD, hybrid physical-chemical vapor deposition, rapid thermal CVD, and vapor phase epitaxy.

Vacuum deposition—vacuum deposition, as used herein, describes family of processes used to deposit layers atom-by-atom or molecule-by-molecule at sub-atmospheric pressure (vacuum) on a solid surface. For example, vacuum deposition may include physical vapor deposition processes, low pressure chemical vapor deposition processes, and plasma enhanced CVD, and combinations thereof.

Chemical solution deposition (CSD)—chemical solution deposition, as used herein, refers to any process wherein a liquid precursor is dissolved in an organic solvent and then cast onto the substrate. For example, CSD can be done through the use of spin-casting or atomizing the precursor and spraying it onto the substrate.

### Characterization of Materials:

The current invention will be optimized both with regard to the electrode and the ferroelectric coating. For example, in order to optimize the coated electrode's properties, it will be necessary to analyze and optimize the following factors: 1) Surface Area (BET analysis); 2) Impurity content (ICP, EDS/WDS); 3) Particle size/morphology (SEM); 4) Crystallography (XRD); 5) Pore size/Distribution; and 6) Conductivity.

The coating should be optimized based on its ability to interact with the carbon electrode. For example, the composition of Ba₁₋ₓSrₓTiO₃ or other ferroelectric material should be optimized based on the desired performance conditions. For example, more Sr²⁺ will shift the Curie point (peak in capacitance vs. temperature curve) to lower temperatures. In some embodiments, for the dielectric material Ba₁₋ₓSrₓTiO₃, x is from about 0 to 1. In some embodiments, x is about 0.05-1, 0.05-0.99, 0.05-0.98, 0.05-0.95, 0.05-0.90, 0.05-0.85, 0.05-0.80, 0.05-0.75, 0.05-0.70, 0.05-0.65, 0.05-0.60, 0.05-0.55, 0.05-0.50, 0.05-0.45, 0.05-0.40, 0.05-0.35, 0.05-0.30, 0.05-0.25, 0.05-0.20, 0.05-0.15, 0.05-0.10, 0.10-0.95, 0.10-0.90, 0.10-0.85, 0.10-0.80, 0.10-0.75, 0.10-0.70, 0.10-0.65, 0.10-0.60, 0.10-0.55, 0.10-0.50, 0.10-0.45, 0.10-0.40, 0.10-0.35, 0.10-0.30, 0.10-0.25, 0.10-0.20, 0.10-0.15, 0.20-0.99, 0.20-0.98, 0.20-0.95, 0.20-0.90, 0.20-0.85, 0.20-0.80, 0.20-0.75, 0.20-0.70, 0.20-0.65, 0.20-0.60, 0.20-0.55, 0.20-0.50, 0.20-0.45, 0.20-0.40, 0.20-0.35, 0.20-0.30, 0.20-0.25, 0.30-0.99, 0.30-0.98, 0.30-0.95, 0.30-0.90, 0.30-0.85, 0.30-0.80, 0.30-0.75, 0.30-0.70, 0.30-0.65, 0.30-0.60, 0.30-0.55, 0.30-0.50, 0.30-0.45, 0.30-0.40, 0.30-0.35, 0.40-0.99, 0.40-0.98, 0.40-0.95, 0.40-0.90, 0.40-0.85, 0.40-0.80, 0.40-0.75, 0.40-0.70, 0.40-0.65, 0.40-0.60, 0.40-0.55, 0.40-0.50, 0.40-0.45, 0.50-0.99, 0.50-0.98, 0.50-0.95, 0.50-0.90, 0.50-0.85, 0.50-0.80, 0.50-0.75, 0.50-0.70, 0.50-0.65, 0.50-0.60, 0.50-0.55, 0.60-0.99, 0.60-0.98, 0.60-0.95, 0.60-0.90, 0.60-0.85, 0.60-0.80, 0.60-0.75, 0.60-0.70, 0.60-0.65, 0.70-0.99, 0.70-0.98, 0.70-0.95, 0.70-0.90, 0.70-0.85, 0.70-0.80, 0.70-0.75, 0.80-0.99, 0.805-0.98, 0.80-0.95, 0.80-0.90, 0.80-0.85, 0.90-0.99, 0.90-0.98, or 0.90-0.95.

The maximum capacitance should be in center of ultracapacitor's operating temperature range. Control of the capacitance to optimize for temperature can be done in a number of ways, such as particle size and dielectric constant. For example, smaller particle size will shift the Curie point to lower temperatures.

The dielectric coating can be optimized based on the dielectric constant. Dielectric constants of the coating materials can be from about 10 to 150,000. In some embodiments, the dielectric constant can be about 10-2,500, 20-2,500, 50-2,500, 100-2,500, 200-2,500, 500-2,500, 1,000-2,500, 10-2,000, 10-1,500, 10-1,000, 10-500, 50-2,000, 50-1,500, 100-2,000, 200-2,000, or 500-2,000. In some embodiments, the dielectric constant of the EDLC can be about 10, 100, 200, 300, 400, 500, 600, 700, 800, 900, 1000, 2000, 3000, 4000, 5000, 6000, 7000, 8000, 9000, 10,000, 20,000, 30,000, 40,000, 50,000, 60,000, 70,000, 80,000, 90,000, 100,000, 110,000, 120,000, 130,000, 140,000, 150,000.

The technique used for coating should be able to produce a material that will optimize the capacitance when used in conjunction with the chosen electrodes. Optimization includes determination of the ratio of coated-to-uncoated electrode surface area, the topology of the coating, and coating thickness for optimal capacitance. The coating may be comprised of a number of particles, a layer of ferroelectric material, multiple layers of materials or a combination of these coating types. Particle size can be optimized so as to balance electrolyte activity with double electrode enhancement. Particle size can be from 1 nm to 500 nm. In some embodiments, the particle size is about 1-500 nm, 2-500 nm, 10-500 nm, 20-500 nm, 20-400 nm, 50-400 nm, 50-300 nm, 10-300 nm, 10-200 nm, 100-300 nm, or 100-500 nm. In some embodiments, dielectric particle size is about 1 nm, 2 nm, 5 nm, 10 nm, 15 nm, 20 nm, 25 nm, 30 nm, 35 nm, 40 nm, 45 nm, or 50 nm.

The coating may be a complete coating or may include uncoated areas (an incomplete or partial coating). The partial coating may comprise, but is not limited to, areas of uncoated and coated regions (patches), individual particles coating the surface, or combinations thereof. The percentage of coated surface area can be from 1-100%. In some embodiments, the percentage of surface coated is from about 10-100%, 20-100%, 30-100%, 40-100%, 50-100%, 60-100%, 70-100%, 80-100%, 90-100%, 95-100%, 98-100%, 99-100%, 50-99%, 60-99%, 70-99%, 80-99%, 90-99%, 50-98%, 60-98%, 70-98%, 80-98%, 90-98%, 50-90%, 60-90%, 70-90%, 80-90%, 50-80%, 50-70%, 50-60%, 60-70%, 20-70%, 20-80%, 30-80%, 30-70%, 30-60%, 60-80%, or 70-80%.

Coating thickness can be optimized so as to balance electrolyte activity with double electrode enhancement. Coating thickness can be from a monolayer of dielectric particles to 500 nm. In some embodiments, the coating thickness is about a monolayer to 400 nm, a monolayer to 300 nm, a monolayer to 200 nm, a monolayer to 100 nm, a monolayer to 90 nm, a monolayer to 80 nm, a monolayer to 70 nm, a monolayer to 60 nm, a monolayer to 50 nm, a monolayer to 40 nm, a monolayer to 30 nm, a monolayer to 20 nm, a monolayer to 10 nm, 20-150, 20-120, 20-100, 2-50 nm, 10-50 nm, 20-50 nm, 2-40 nm, 5-40 nm, 5-30 nm, 10-30 nm, 1-20 nm, 1-50 nm, 1-10 nm, 10-30 nm, 10-40 nm, or 10-20 nm. In some embodiments, coating thickness can be about a monolayer, 1 nm, 2 nm, 5 nm, 10 nm, 15 nm, 20 nm, 25 nm, 30 nm, 35 nm, 40 nm, 45 nm, 50 nm, 60 nm, 70 nm, 80 nm, 90 nm, 100 nm, 200 nm, 300 nm, 400 nm, or 500 nm.

The use of the word “a” or “an” when used in conjunction with the term “comprising” in the specification may mean “one,” but it is also consistent with the meaning of “one or more,” “at least one,” and “one or more than one.” The term “about” references all terms in the range unless otherwise stated. For example, about 1, 2, or 3 is equivalent to about 1, about 2, or about 3, and further comprises from about 1-3, from about 2, and from about 2-3.

Unless defined otherwise, all technical and scientific terms herein have the same meaning as commonly understood by one of ordinary skill in the art to which this invention belongs. Although any methods and materials, similar or equivalent to those described herein, can be used in the practice or testing of the present invention, the preferred methods and materials are described herein.

The present invention may have use in a variety of applications such as, but not limited to, industrial applications, commercial applications, and military applications. Regardless of detailed embodiments, applicability of the invention is not meant to be limiting. Other objects, features and advantages of the present invention are apparent from the detailed description. Those skilled in the art will recognize the embodiments described herein may be modified or altered without departing from the true spirit and scope of the invention. For example, the linear axes shown in the drawings may have more complicated paths, or the axes may be oriented along planes other than the conventional XYZ planes, or the size, shape and physical properties of the device may be altered.

### EXAMPLES

### Prospective Example 1

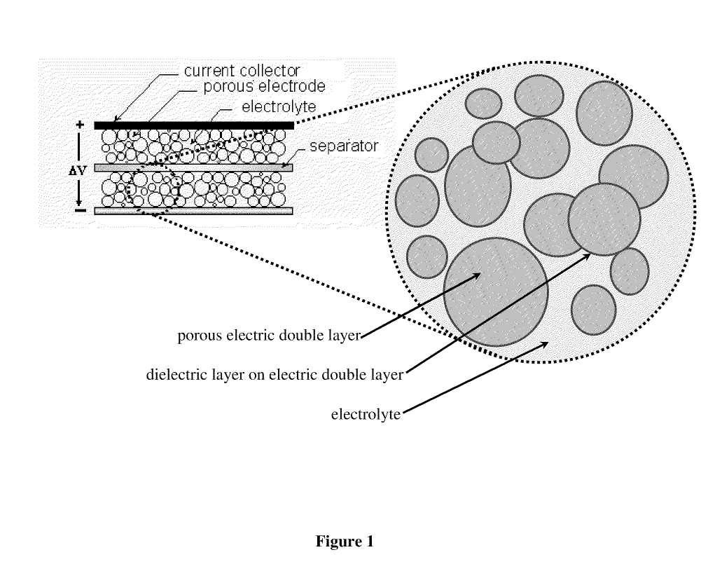

FIG. 1 shows a schematic of a theoretical EDLC-based ultracapacitor that would be composed of a positive and negative current collector, a porous carbon-based electrode that would be coated with a dielectric material to enhance capacitance of the EDLC, a separator film, and an electrolyte in the space surrounding the electrode material. Without being limited to one theory of how the coating improves the capacitance, it is believed that the presence of the dielectric layer creates another electric field beyond the double layer forming a multilayer capacitor. The extra layers could allow the electrochemical double layer capacitor to store more energy than a EDLC with only a carbon electrode.

### Prospective Example 2

### 2a. Ceramic Nanoparticles with Giant Dielectric Constants

Su et al. (WO 2008/153585, herein incorporated by reference) have established the first facile open-bench synthesis of BaTiO₃, SrTiO₃ nanocrystals, and their solid solutions Ba₁₋ₓSrₓTiO₃ (BSTO) at 80° C. The size of the BSTO nanoparticles can be readily tuned down to the level of 10 nm with achievable giant dielectric constants ˜140,000. The process yields these important perovskite mixed-metal oxide crystals of high quality on the nanometer scale without a history of thermal stress. Following procedures established in WO 2008/153585, ferroelectric nanoparticles of different levels of dielectric constants, up to 140,000, and size range 20 to 500 nm will be synthesized to be used as dispersoid to construct nanocomposites with a bank of tailored-made PEO copolymers described below (FIG. 2).

### 2b. Composite Polymer Electrolytes

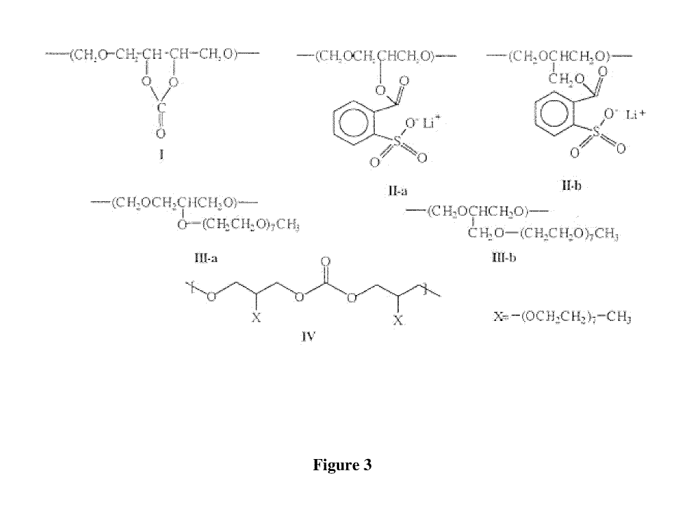

The critical attribute required for polymer ionic conductors is high ionic conductivity coupled with excellent dimensional stability at service temperatures. A number of factors governing ionic conductivity have been known. Large amplitude polymer segmental motion, favorable ion-dipole interaction between cation charge carrier and polymer, large disparity in the sizes of cation and anion as well as local environment with high dielectric constant have been established to be among the favorable conditions. Synthetic attempts to maximize conductivity have been mostly to prepare separate components with desirable characteristics and blends them into composites. Blend systems as such suffer from the disadvantages of low dimensional stability and non-uniform distribution of functionalities and components. The adverse effect of the high local concentration of the sulfonate group may be significant considering the required low sulfonate/carbonate mole ratio of 1:5 reported for high conductivity. One possible method of producing a polymer electrolyte is to combine the building blocks listed in FIG. 3 into a single macromolecular chain using known methods.

### Example 3

Preliminary Coating Experiments: Techniques for depositing the coating on the electrode include, but are not limited to, the following:

1) Electrophoretic Deposition—The electrodes were immersed in a conductive medium (i.e. H₂O) in which the ceramic was suspended and a potential was applied between the electrodes and the medium, causing the oppositely charged ceramic particles in the medium to migrate and deposit on the electrodes. The extent of coverage of the electrodes and the thickness of the deposited layer was shown to be dependent on both the potential difference between the electrodes and the solution and the time the potential is applied.

2) Sol-gel synthesis—Alkoxide or metal chloride precursor materials will be mixed together and heated at a controlled temperature and time. Ceramic particles will precipitate out through condensation reactions as the temperature is increased and the solvent evaporates. The surface of the carbon electrode will act as a seed and cause precipitation to occur directly on its surface. Particle size will also be controlled down to 1-2 nm with some materials.

### Example 4

### Electrophoretic Deposition of Barium/Strontium Titanates (BTO, STO, BSTO)

Using two aluminum plates held in place by a plastic framework, and connected with a piece of copper, BSTO (chemical formula: Ba_{0.67}Sr_{0.33}TiO₃ and Ba_{0.80}Sr_{0.20}TiO₃) was electrophoretically deposited onto the carbon electrical double layer. Testing verified an increase in capacitance versus non-doped electrical double layer.

To test the effects of BSTO, the non-doped carbon was first examined in a three electrode electrochemical cell. The samples were charged, held at voltage, then discharged, and capacitance measured over the entire voltage range. The results are shown below:

| | | ESR | AC lmp @ 1 kHz |
|---|---|---|---|
| Trial # | Cap (F) | (mOhm) | (Ohm) |
| 1 | 2.155 | 3.080 | 0.027 |
| 2 | 2.144 | 3.210 | 0.040 |
| 3 | 2.232 | 3.870 | 0.057 |
| 4 | 2.207 | 3.788 | 0.017 |
| 5 | 2.338 | 3.097 | 0.059 |
| 6 | 2.203 | 4.414 | 0.097 |
| 7 | 2.293 | 3.956 | 0.070 |
| 8 | 2.186 | 4.120 | 0.035 |
| 9 | 2.220 | 3.660 | 0.106 |
| 10 | 2.339 | 4.280 | 0.116 |
| 11 | 2.227 | 4.160 | 0.081 |
| 12 | 2.231 | 4.220 | 0.062 |
| Average | 2.231 | 3.821 | 0.064 |
| Stdev | 0.063 | 0.469 | 0.032 |
| % | 5.657 | 24.550 | 85.345 |
| Error | | | |

For the BSTO doped samples, they were put into the setup described above, and a 3 g/L BSTO in H₂O solution was added, and the samples run at 15 V (5V/cm.) The samples were then dried for twelve hours at 120° C. before being tested. In some cases, the solution used had its pH adjusted by a base, and a surfactant was used to help steady the suspension. In other cases, neither a base nor a surfactant was used but the times were changed. The results below clearly show an increase in the capacitance of the electrode from the addition of BSTO. The percent change in the average capacitance from non-doped to doped (of all conditions) was 46.1%.

| | Cap | ESR | AC lmp @ 1 kHz |
|---|---|---|---|
| Trial # | (F) | (mOhm) | (Ohm) |
| ph 10-1 | 3.342 | 5.760 | 0.058 |
| pH 10-2 | 3.249 | 4.160 | 0.047 |
| pH 10-3 | 3.260 | 3.366 | 0.025 |
| pH 6.5-20 min | 3.354 | 3.780 | 0.034 |
| pH 6.5-10 min | 3.223 | 2.320 | 0.059 |
| pH 6.5-90 min | 3.128 | 3.360 | 0.039 |
| Average | 3.259 | 3.791 | 0.044 |
| Stdev | 0.083 | 1.144 | 0.013 |
| % Error | 5.085 | 60.353 | 61.691 |

1. A device comprising:
a. an electric double-layer capacitor (“EDLC”) comprising:
(1) a positively charged current collector;
(2) a negatively charged current collector;
(3) a positive electrode in contact with the positively charged current collector;
(4) a negative electrode in contact with the negatively charged current collector;
(5) an electrolyte; and
(6) a separator; and
b. a dielectric material;
wherein the dielectric material is in physical contact with at least one of the electrodes of the EDLC.

2. The device of claim 1, wherein at least one electrode comprises carbon.

3. The device of claim 2, wherein the carbon comprises a porous structure.

4. The device of claim 3, wherein the porous structure comprises a pore size distribution, as determined from a nitrogen adsorption isotherm, in which pores with a radius of up to 100 Å account for at most 50% of the total pore volume.

5. The device of claim 3, wherein the carbon has a density of about 0.2 to 2.5 g/cm³.

6. The device of claim 3, wherein the carbon comprises single-walled carbon nanotubes, fullerenes, multi-walled carbon nanotubes, diamond-like carbon, diamond, nanocrystalline diamond, diamondoids, amorphous carbon, carbon particles, carbon powder, microspheres, graphite, graphene, graphitic polyhedral crystals, highly ordered pyrolytic graphite, activated carbon, or hydrogenated amorphous carbon

7. The device of claim 6, wherein the carbon comprises activated carbon with an average particle size less than 20 nm.

8. The device of claim 6, wherein the carbon has a specific surface area greater than 500 m²/g as measured by the nitrogen adsorption BET method.

9. The device of claim 1, wherein the electrolyte comprises an aqueous, non-aqueous, or polymeric material.

10. The device of claim 9, wherein the electrolyte comprises a polymer.

11. The device of claim 10, wherein said polymer comprises a PEO-based copolymer.

12. The device of claim 1, wherein the dielectric compound comprises a ferroelectric, piezoelectric, or pyroelectric material.

13. The device of claim 12, wherein the dielectric compound further comprises an inorganic compound or a polymer.

14. The device of claim 13, wherein the dielectric compound comprises an inorganic compound.

15. The device of claim 14, wherein the inorganic compound comprises a ceramic.

16. The device of claim 13, wherein the dielectric compound comprises a colloid, a mixture, a film, adhered particles, or deposited particles.

17. The device of claim 13, wherein the dielectric compound further comprises nanoparticles, microparticles, or a film.

18. The device of claim 17, wherein the dielectric compound comprises a film.

19. The device of claim 17, wherein the dielectric compound comprises nanoparticles.

20. The device of claim 13, wherein the inorganic compound or polymers comprises barium titanate, strontium titanate, barium strontium titanate, bismuth ferrite, colemanite, germanium telluride, lead scandium tantalate, lead zirconium titanate, lithium niobium oxide, polyvinylidene fluoride, potassium sodium tartrate, or potassium titanium phosphate.

21. The device of claim 13, wherein the inorganic compound comprises Ba₁₋ₓSrₓTiO₃, PbZr₁₋ₓTiₓO₃ or Pb_{y}La_{z}(Zr₁₋ₓTiₓ)O₃ wherein x is between from about 0.0 to about 1.0, y is from about 0.95 to about 1.25 and z is between from about 0 to about 0.15, Bi₃ₓZn₂₍₁₋ₓ₎Nb₂₋ₓO₇ wherein x is between from about 0.40 to about 0.75, or SrₓBi_{y}Ta₂O_{5+x+3y/2} wherein x is between from about 0.50 to about 1.0 and y is between from about 1.9 to about 2.5.

22. The device of claim 21, wherein the inorganic compound comprises Ba₁₋ₓSrₓTiO₃ wherein x is between from about 0.0 to about 1.0.

23. The device of claim 17, wherein the particles or film are chemically bound, adhered to, adsorbed to, precipitated on, or deposited on at least one electrode.

24. The device of claim 19, wherein the nanoparticles comprise a film.

25. The device of claim 19, wherein the average size of the nanoparticles comprises from about 1 nm to about 500 nm.

26. The device of claim 18 or 24, wherein the thickness of the film comprises from about a monolayer to about 1000 nm.

27. The device of claim 13, wherein the energy density of the device is greater than 30 Wh/kg.

28. A method of making the device of claim 2, comprising:
forming a dielectric material; and
placing said dielectric material in physical contact with at least one of said electrodes.

29. A method of claim 28, further comprising simultaneously charging the electrode and polarizing said dielectric material.

30. The method of claim 28, wherein said physical contact comprises chemically binding, adhering, adsorbing, precipitating, or depositing said dielectric material.

31. The method of claim 28, wherein said forming a dielectric material comprises coprecipitation, hydrothermal methods, solvothermal methods, sol-gel processes, processes mediated by molten composite hydroxide, room-temperature synthesis, biological synthesis, low-temperature synthesis, or synthesis using reverse micelles.

32. The method of claim 31, wherein said forming a dielectric material comprises a low-temperature synthesis.

33. The method of claim 33, wherein said low-temperature synthesis occurs at temperatures less than 100° C. at standard pressure.

34. The method of claim 28, wherein said placing said dielectric material comprises electrophoretic deposition, sol-gel synthesis, atomic layer deposition, physical vapor deposition, chemical vapor deposition, vacuum deposition, or chemical solution deposition.

35. The method of claim 34, wherein the deposition method comprises electrophoretic deposition or chemical solution deposition.

36. A hybrid device comprising:
a. said device of any of claim 1 to 25 or 27; and
b. battery.
